(19) United States
(12) Patent Application Publication
(10) Pub. No.: US 2014/0063238 A1
(43) Pub. Date: Mar. 6, 2014

(54) CAMERA SENSOR HAVING REVERSIBLE SENSOR HOUSING AND REVERSIBLE ADAPTER

(71) Applicants: Joshua Abdollahzadeh, Denver, NC (US); Robert S. Schultz, Charlotte, NC (US)

(72) Inventors: Joshua Abdollahzadeh, Denver, NC (US); Robert S. Schultz, Charlotte, NC (US)

(73) Assignee: INVUE SECURITY PRODUCTS INC., Charlotte, NC (US)

(21) Appl. No.: 13/632,469

(22) Filed: Oct. 1, 2012

Related U.S. Application Data
(60) Provisional application No. 61/697,587, filed on Sep. 6, 2012.

(51) Int. Cl. H04N 7/18

(52) U.S. Cl. 348/143; 348/E07.085

(57) ABSTRACT

A camera sensor for a merchandise display security device is provided for displaying and protecting cameras against theft. In one embodiment, the camera sensor includes a display stand configured for receiving a sensor base and a reversible sensor housing configured for being attached to a camera and positioned on the sensor base in opposite orientations. The sensor base includes a body having a topside defining a symmetric geometry and the sensor housing includes a body having an underside defining a symmetric geometry complimentary to the symmetric geometry of the sensor base. In another embodiment, the camera sensor further includes a reversible adapter configured for being attached to a camera and positioned on a sensor housing in opposite orientations. The sensor housing has an opening defining a symmetric geometry and the adapter includes a body defining a symmetric geometry complimentary to the symmetric geometry of the sensor housing.

### FIELD OF THE INVENTION

The present invention relates generally to merchandise display security systems and methods for displaying and protecting items of merchandise against theft. More particularly, the invention relates to a camera sensor for a merchandise display security device that is reversible to permit a retailer to readily display cameras, video recorders, and the like in a forward-facing or a rearward-facing orientation.

### BACKGROUND OF THE INVENTION

It is common practice for retailers to display relatively expensive items of merchandise on a merchandise display security device, such as an alarming display stand. The security device displays an item of merchandise so that a potential purchaser can readily view and, in some instances, operate the item when making a decision whether to purchase the item. At the same time, the item of merchandise is usually physically secured on the security device so as to prevent, or at least deter, theft of the item. The merchandise display security device may also include an audible and/or visible alarm that is activated to alert store personnel in the event that a shoplifter attempts to separate the item of merchandise from the security device.

Oftentimes, the retailer desires to supply the item of merchandise with electrical power so that the potential purchaser can further evaluate its operating features. While most items of electronic merchandise include an internal source of power (e.g. battery), it is not always feasible or practical to utilize the internal power source of the merchandise since a battery requires periodic replacement or recharging. In addition, the battery charge may dissipate while the item of merchandise is on display and render the merchandise inoperable, in which case the potential purchaser may be discouraged from purchasing the item. Accordingly, it is known to configure a merchandise display security device with a power adapter cord, commonly referred to as a “pigtail,” for supplying electrical power to an item of merchandise from an external power source. In addition, it is known when necessary to provide the merchandise display security device with a current and/or voltage regulator that is operable for supplying an appropriate operating current and/or voltage to the item of merchandise.

Retailers especially like to display cameras, video recorders, and the like on a merchandise display security device since a potential purchaser will typically desire to experience physical characteristics and operating features of the merchandise such as size, weight, balance, tactile comfort and the quality of the image seen through the viewfinder or on the video screen. Accordingly, merchandise display security devices that supply power to the merchandise and include a sensor removably mounted on a display stand have been developed for use with handheld cameras, tripod mount cameras, single-lens reflex (SLR) cameras, digital single-lens reflex (DSLR) cameras, camcorders, and the like (collectively referred to herein as “cameras”). Examples of such merchandise display security devices include the Series 900 and Series 1000 Power Puck™ display stands available from InVue Security Products Inc. of Charlotte, N.C., USA. Camera sensors for use with the Series 900 and Series 1000 Power Puck display stands take advantage of the standard-sized, internally threaded tripod mounting hole provided on most cameras to secure the camera to the camera sensor.

Unfortunately for retailers, cameras, video recorders and the like have various shapes and sizes. For example, a DSLR camera with a removable lens is substantially larger and heavier than a “point and shoot” handheld camera. Furthermore, DSLR cameras and camcorders are typically non-symmetrical and unbalanced front-to-rear. In addition, the features of certain cameras are best viewed from the front, while the features of other cameras are best viewed from the rear. As a result, different camera sensors are required for mounting the various cameras, video recorders and the like onto the merchandise display security device in the desired position and orientation for display. The use of numerous different camera sensors, however, complicates installation of the merchandise display security device and requires the retailer to maintain a sufficient inventory of each of the different sensors. In either case, both the cost and complexity incurred by the retailer to protect different cameras, video recorders and the like is unnecessarily increased.

Accordingly, there exists an unresolved need for a camera sensor configured for use with a merchandise display security device for displaying and protecting different cameras, video recorders and the like in a retail store that overcomes the disadvantages of known camera sensors. There exists a specific need for a camera sensor for a merchandise display security device that can be configured for use with larger cameras and video recorders, such as DSLR cameras and camcorders, as well as smaller cameras, such as “point-and-shoot” or “handheld” cameras, without interfering with the merchandise display or interfering with the operation and evaluation of the merchandise by a potential purchaser. There exists a further need for a camera sensor that accommodates cameras of various shapes and sizes. There exists a still further need for a camera sensor for use with a merchandise display security device that can be positioned on a display stand in at least two different display orientations without requiring the camera to be removed and repositioned on the sensor.

### BRIEF DESCRIPTION OF THE DRAWINGS

The detailed description of the invention provided herein may be better understood with reference to the accompanying drawing figures, which depict one or more exemplary embodiments of a camera sensor for a merchandise display security device in accordance with the present invention.

FIG. 1 shows various components of a merchandise display security device including a camera sensor having a reversible sensor housing and a reversible adapter according to the present invention.

FIG. 2 shows a digital single-lens reflex (DSLR) camera and an exemplary embodiment of a merchandise display security device including a camera sensor having a reversible sensor housing according to the present invention in an unassembled configuration.

FIG. 3 shows the DSLR camera and the merchandise display security device of FIG. 2 in an assembled configuration.

FIG. 4 shows the DSLR camera and the merchandise display security device of FIG. 3 with the reversible sensor housing positioned so as to display the DSLR camera in a forward-facing orientation.

FIG. 5 shows the DSLR camera and the merchandise display security device of FIG. 3 with the reversible sensor housing positioned so as to display the DSLR camera in a rearward-facing orientation.

FIG. 6 is a front view of the DSLR camera and the merchandise display security device of FIG. 4 illustrating the reversible sensor housing and the DSLR camera releasably retained on the merchandise display security device.

FIG. 7 is a perspective view of the DSLR camera and the merchandise display security device of FIG. 4 illustrating the reversible sensor housing and the DSLR camera removed from the merchandise display security device.

FIG. 8 shows a handheld camera and the components of another exemplary embodiment of a merchandise display security device including a camera sensor having a reversible sensor housing and a reversible adapter according to the present invention in an unassembled configuration.

FIG. 9 shows the handheld camera and the merchandise display security device of FIG. 8 in an assembled configuration.

FIG. 10 shows the handheld camera and the merchandise display security device of FIG. 9 with the reversible sensor housing positioned so as to display the handheld camera in a forward-facing orientation.

FIG. 11 shows the handheld camera and the merchandise display security device of FIG. 9 with the reversible sensor housing positioned so as to display the handheld camera in a rearward-facing orientation.

FIG. 12 shows the handheld camera and the merchandise display security device of FIG. 9 with the reversible adapter positioned so as to display the handheld camera in a recessed forward-facing orientation.

FIG. 13 shows the handheld camera and the merchandise display security device of FIG. 9 with the reversible adapter positioned so as to display the handheld camera in a recessed rearward-facing orientation.

FIG. 14 is a rear view of the handheld camera and the merchandise display security device of FIG. 12 illustrating the reversible adapter and the handheld camera releasably retained on the merchandise display security device.

FIG. 15 is a rear view of the handheld camera and the merchandise display security device of FIG. 12 illustrating the reversible adapter and the handheld camera removed from the merchandise display security device.

### DETAILED DESCRIPTION OF EXEMPLARY EMBODIMENTS OF THE INVENTION

Referring now to the accompanying drawing figures wherein like reference numerals denote like elements throughout the various views, one or more exemplary embodiments of a camera sensor for a merchandise display security device are shown. Merchandise display security devices suitable for use with the present invention include, but are not limited to, alarm modules and alarming display stands, such as the Series 900 and Series 1000 Power Puck™ display stands available from InVue Security Products Inc. of Charlotte, N.C., USA. However, those of ordinary skill in the art will readily appreciate that camera sensors and sensors for other types of merchandise constructed in accordance with the present invention are useable with other merchandise display security devices and merchandise display systems. A camera sensor according to the present invention is advantageously useable with devices and systems that require power to be supplied to an item of merchandise from an external power source, such as a direct current (DC) transformer in electrical communication with a source of alternating current (AC) electricity.

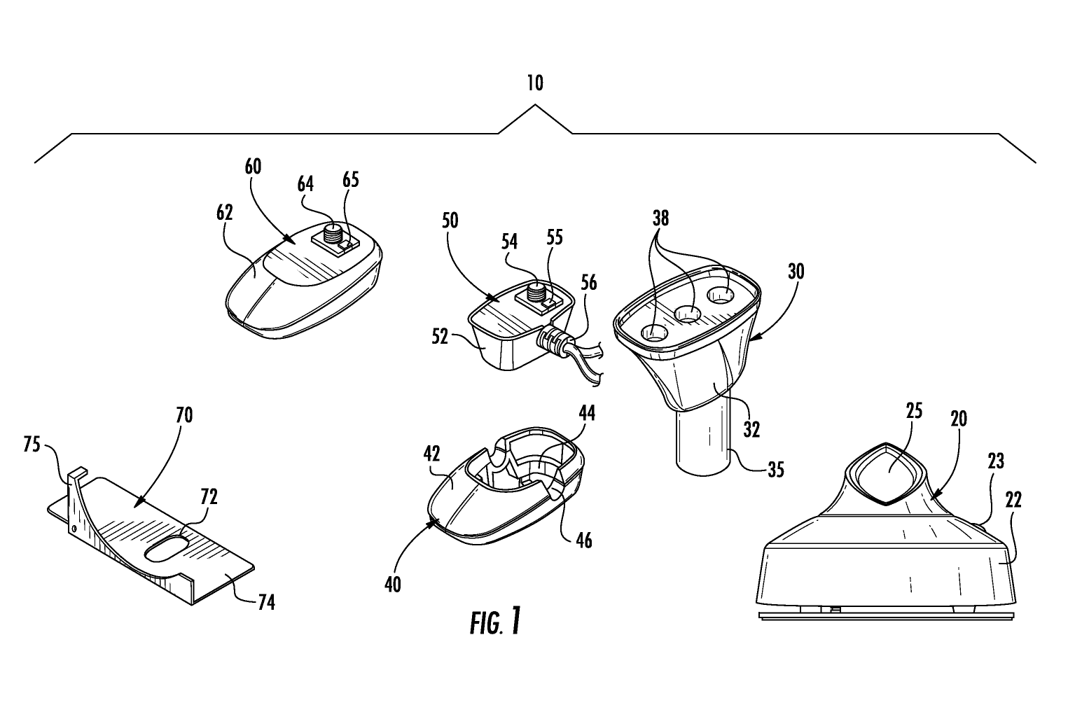

FIG. 1 shows various components of a merchandise display security device, indicated generally at 10, including a camera sensor having a reversible sensor housing and a reversible adapter according to the invention. As shown, the merchandise display security device 10 comprises a Series 900 Power Puck™ merchandise display stand, indicated generally at 20, available from InVue Security Products Inc. of Charlotte, N.C., USA. Display stand 20 is illustrated with alternative embodiments of the camera sensor configured for use with the display stand. In one exemplary embodiment, the camera sensor comprises a sensor base 30 and a reversible sensor housing 60 configured for use with larger cameras and video recorders, such as digital single-lens reflex (DSLR) cameras and camcorders. In another exemplary embodiment, the camera sensor comprises sensor base 30, a reversible sensor housing 40 and a reversible adapter 50 configured for use with smaller cameras, commonly referred to as “point and shoot” or “handheld” cameras. In yet another exemplary embodiment, the reversible adapter 50 may be secured to the reversible sensor housing 40 for use with DSLR cameras and camcorders, thereby eliminating the additional need for reversible sensor housing 60.

FIG. 1 also shows an optional bracket 70 for protecting a removable camera lens or a removable internal battery against theft. Although not illustrated herein, the bracket 70 may positioned between the sensor housing 60 and a DSLR camera, or alternatively between the adapter 50 and a handheld camera, to protect the removable lens or the removable battery, respectively. As such, the bracket 70 has a slot 72 formed therein sized and shaped to be received on sensor housing 60, or alternatively, on adapter 50. Slot 72 is positioned over externally-threaded fastener 64, 54, respectively, operable for engaging the internally-threaded tripod mount provided on most DSLR and handheld cameras. Bracket 70 further comprises a base plate 74 and a retaining arm 75 that depends upwardly from the base plate to abut or engage the removable lens of a DSLR camera or the battery compartment door of a handheld camera.

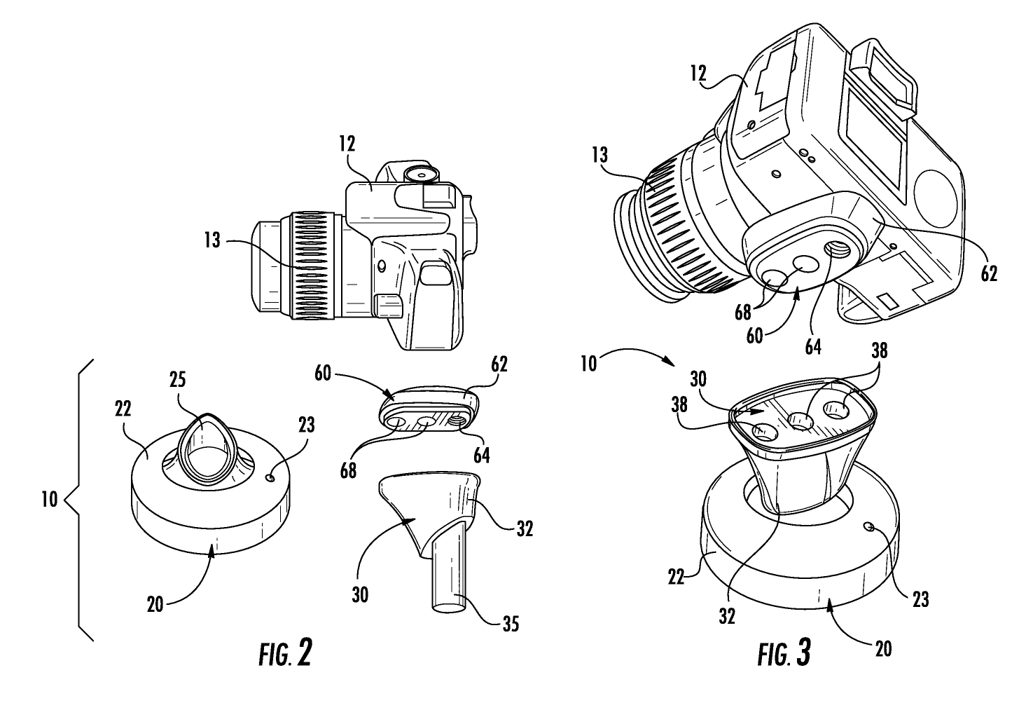

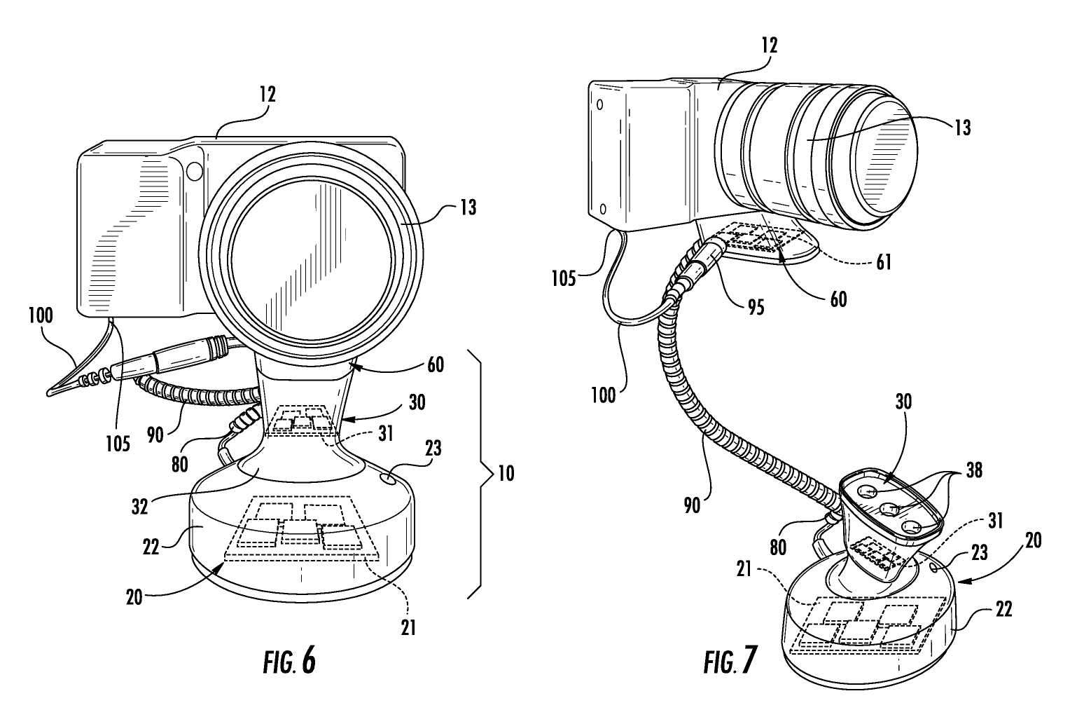

FIGS. 2-7 show a merchandise display security device 10 including an exemplary embodiment of a camera sensor having a reversible sensor housing 60 according to the invention configured for use with a DSLR camera 12 having a removable lens 13. FIG. 2 shows the DSLR camera 12 and the components of the merchandise display security device 10 in an unassembled configuration. The security device 10 comprises display stand 20, sensor base 30 and reversible sensor housing 60. Display stand 20 defines a generally hollow body 22 containing monitoring electronics 21 (FIG. 6 and FIG. 7) that monitor the state of a sensor switch 65 (FIG. 1) for detecting whether the DSLR camera 12 is securely attached to the sensor housing 60. Typically, body 22 also contains an audible alarm and/or a visible alarm, such as LED 23, that is activated when the monitoring electronics 21 detects that the sensor switch 65 indicates an “unsecured” or “alarm” state. The body 22 of display stand 20 has a recess or opening 25 that is sized and shaped to receive a stem 35 of the sensor base 30. In that regard, sensor base 30 comprises a body 32 and a stem 35 depending from the body that is configured to be received within the opening 25 of the display stand 20. The stem 35 of the sensor base 30 may be permanently affixed to the body 22 within the opening 25 of the display stand 20. Preferably, however, stem 35 is received within the opening 25 of the display stand 20 in a secure interference fit so that a camera sensor according to the invention is interchangeable on a different display stand 20. Furthermore, the body 22 of display stand 20 and the stem 35 of the sensor base 30 may each be provided with complimentary external and/or internal geometry features for aligning sensor base 30 relative to display stand 20 in a predetermined desired orientation.

FIG. 3 shows the DSLR camera 12 and the components of the merchandise display security device 10 in an assembled configuration. In particular, FIG. 3 shows the stem 35 of the sensor base 30 disposed within the opening 25 of the display stand 20 and the sensor housing 60 attached to the underside of the DSLR camera 12. Sensor housing 60 comprises a body 62 that retains a captive, externally-threaded fastener 64 operable for engaging an internally-threaded tripod mount (not shown) provided on the underside of the DSLR camera 12. As best shown in FIG. 1, sensor housing 60 further comprises sensor switch 65 that is biased in an extended position. As such, sensor switch 65 moves from the extended position to a retracted, or depressed, position as the fastener 64 secures the DSLR camera 12 onto the sensor housing 60. In the depressed position, the sensor switch 65 completes (i.e. closes) an electronic monitoring circuit of sensor electronics 61 disposed within the body 62 of the sensor housing 60 that is electrically connected to monitoring electronics 21 disposed within display stand 20, as will be described, to indicate that the DSLR camera 12 is securely attached to the sensor housing. In the event that a potential thief attempts to separate the DSLR camera 12 from the sensor housing 60, for example by unscrewing fastener 64, or alternatively, by rotating the camera relative to the sensor housing, biased sensor switch 65 extends and interrupts (i.e. opens) the monitoring circuit of sensor electronics 61 to indicate that the DSLR camera is no longer securely attached to the sensor housing. In response to the sensor switch 65 changing from a “secured” state to an “unsecured” or “alarm” state, the monitoring electronics 21 of the display stand 20 activate the audible alarm and/or visible alarm (e.g. LED 23) to alert store personnel to a possible theft.

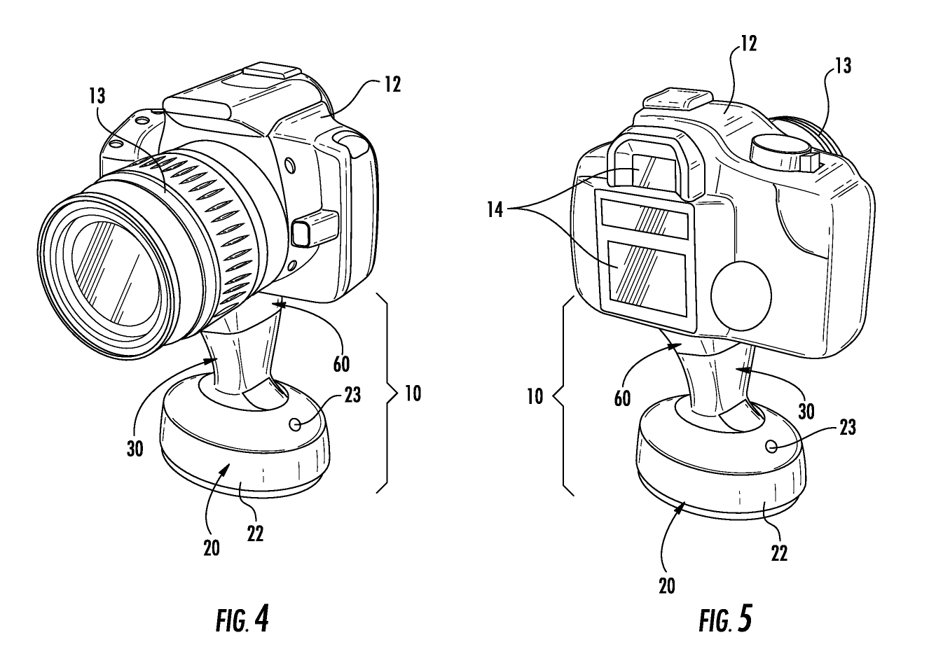

As shown, the underside of the body 62 of the sensor housing 60 has a geometry that is complimentary to the geometry of the topside of the body 32 of the sensor base 30 for a purpose to be explained hereafter with reference to FIGS. 4 and 5. Furthermore, as shown herein, the geometry of the topside of the body 32 of the sensor base 30 and the geometry of the underside of the body 62 of the sensor housing 60 are both complimentary and symmetric to one another. As a result, the sensor housing 60 may be positioned on the sensor base 30 in either one of two different, and opposite, orientations. The body 32 of sensor base 30 is provided with one or more magnets 38 and body 62 of sensor housing 60 is provided with one or more complimentary magnets 68 for releasably retaining the sensor housing on the sensor base. As shown, sensor base 30 has three openings formed in the topside of body 32 each receiving a magnet 38, or alternatively, an insert made of a magnetically attractive material. On the other hand, sensor housing 60 has two adjacent openings formed in the underside of body 62 each receiving a magnet 68, or alternatively, an insert made of a magnetically attractive material. As will be readily apparent to those skilled in the art, a magnet and an opposed complimentary magnetically attractive material disposed on the sensor base 30 and the sensor housing 60, respectively, releasably retain the sensor housing on the sensor base in either of the two different, and opposite, orientations.

FIG. 4 shows the DSLR camera 12 and the merchandise display security device 10 in a fully assembled configuration for displaying and protecting the DSLR camera against theft. The DSLR camera 12 is attached to the reversible sensor housing 60 and the sensor housing is in turn positioned on the sensor base 30 and display stand 20 in a desired one of the two different, and opposite, orientations. As shown in FIG. 4, the reversible sensor housing 60 is releasably retained on the sensor base 30 with the DSLR camera 12 displayed in a “forward-facing” orientation so that the removable lens 13 of the DSLR camera is prominently displayed to a potential purchaser. A retailer may desire to display the DSLR camera 12 in the forward-facing orientation for the purpose of drawing the potential purchaser's attention to the lens 13, which may be a relatively expensive accessory having a higher profit margin than the DSLR camera.

FIG. 5 likewise shows the DSLR camera 12 and the merchandise display security device 10 in a fully assembled configuration for displaying and protecting the DSLR camera against theft. The DSLR camera 12 is attached to the reversible sensor housing 60 and the sensor housing is in turn positioned on the sensor base 30 and display stand 20 in the other of the two different, and opposite, orientations. As shown in FIG. 5, the reversible sensor housing 60 is releasably retained on the sensor base 30 with the DSLR camera displayed in a “rearward-facing” orientation so that the viewfinder/video screen 14 of the DSLR camera is prominently displayed to a potential purchaser. A retailer may desire to display the DSLR camera 12 in the rearward-facing orientation for the purpose of drawing the potential purchaser's attention to the quality and characteristics of the viewfinder/video screen 14, which may be a distinguishing feature of that model of DSLR camera.

It should be noted that in both the forward-facing orientation and the rearward-facing orientation, the expanded footprint of the body 62 of the sensor housing 60 in conjunction with the extended stem 35 of the sensor base 30 function to support the weight of the DSLR camera and to counteract any eccentric moment produced by the aggregate center-of-gravity of the combined DSLR camera 12 and removable lens 13 on display stand 20.

FIG. 6 shows the DSLR camera 12 and the merchandise display security device 10 with the sensor housing 60 attached to the DSLR camera and positioned on the sensor base 30 such that the DSLR camera is displayed in the forward-facing orientation. FIG. 7 shows the DSLR camera 12 and the reversible sensor housing 60 attached thereto removed from the sensor base 30, for example, so that the DSLR camera may be evaluated by a potential purchaser. As shown in FIG. 6 and FIG. 7, a first multi-conductor cable 80 extends between the body 22 of the display stand 20 and the body 32 of the sensor base 30 to electrically interconnect monitoring electronics 21 disposed within the display stand with regulator electronics 31 disposed within the sensor base. Regulator electronics 31 supply an appropriate operating current and/or voltage to the DSLR camera 12. The operating current and/or voltage supplied by regulator electronics 31 is usually different than that required for the merchandise security display device 10 and oftentimes varies depending on the particular type or model of the DSLR camera 12 being displayed. Display stand 20 may contain an internal battery for providing power to the monitoring electronics 21 and the regulator electronics 31, or alternatively or additionally, may comprise a main power cord (not shown) that is electrically connected to an external power source, such as a direct current (DC) transformer and an alternating current (AC) electrical outlet.

A second multi-conductor cable 90 extends between the sensor base 30 and the sensor housing 60. The second cable 90 comprises conductors that carry the appropriate operating current and/or voltage for the DSLR camera 12 from the regulator electronics 31. Second cable 90 further comprises conductors that electrically interconnect the monitoring electronics 21 disposed within the body 22 of the display stand 20 with sensor electronics 61 disposed within the sensor housing 60 and electrically connected to the sensor switch 65 that engages the underside of the DSLR camera 12. If desired, current and/or voltage feedback electronics may also be provided on sensor electronics 61 disposed within the sensor housing 60 for increasing or decreasing the amount of current and/or voltage needed for operating the DSLR camera 12. Cable 90 has a suitable length, or alternatively, is an extensible and retractable cable, such as the helical coil cable shown herein, to allow a potential purchaser to closely examine and operate the DSLR camera 12 at a comfortable distance away from the display stand 20 and sensor base 30.

As shown herein, a third multi-conductor cable 100 extends between the sensor housing 60 and the DSLR camera 12. The third cable 100 comprises conductors that carry the appropriate operating current and/or voltage from the regulator electronics 31 disposed within the sensor base 30 to a power input port 105 provided on the DSLR camera 12. As readily appreciated and understood by those skilled in the art, any of the cables 80, 90, 100 may be provided with releasable connectors on one or both ends, or alternatively, may be hard-wired directly to the corresponding electronics 21, 31, 61 disposed within display stand 20, sensor base 30 and sensor housing 60, respectively. Preferably, at least the end of the cable 80 that is connected to the display stand 20 is provided with a releasable connector so as to facilitate the interchangeability of different display stands with the same sensor base 30. Similarly, the end of cable 90 that is connected to the sensor housing 60 may be provided with a releasable connector so as to facilitate the interchangeability of different sensor housings with the same sensor base 30. Preferably, both ends of the cable 100 are provided with a releasable connector, and the cable 90 or the sensor housing 60 is provided with a connector 95 that has a standard configuration so as to facilitate the use of the same sensor housing 60 with different cables 100 commonly referred to in the art as “power adapter cords” or “pigtails” having different connectors compatible with the configuration of the power input port 105 provided on the DSLR camera 12.

It should be noted that the complimentary geometry of the topside of the sensor base 30 and the underside of the sensor housing 60 permits a potential purchaser to replace the DSLR camera 12 with the reversible sensor housing on sensor base 30 and display stand 20 in either the forward-facing orientation or the rearward-facing orientation. Furthermore, adjacent magnets 68 provided on the underside of the sensor housing 60 are arranged to be positioned opposite an adjacent pair of the magnets 38 provided on the topside of the sensor base 30 in either the forward-facing orientation or the rearward-facing orientation.

FIGS. 8-15 show a merchandise display security device 10 including another exemplary embodiment of a camera sensor having a reversible sensor housing 40 and a reversible adapter 50 according to the invention configured for use with a handheld camera 15. FIG. 8 shows the handheld camera 15 and the components of the merchandise display security device 10 in an unassembled configuration. The security device 10 comprises display stand 20, sensor base 30, reversible sensor housing 40 and reversible adapter 50. As previously described, display stand 20 defines a generally hollow body 22 containing monitoring electronics 21 (FIG. 6 and FIG. 7) that monitor the state of a sensor switch 55 (FIG. 1 and FIG. 8) for detecting whether the handheld camera 15 is securely attached to the adapter 50. Typically, body 22 also contains an audible alarm and/or a visible alarm, such as LED 23, that is activated when the monitoring electronics 21 detects that the sensor switch 55 indicates an “unsecured” or “alarm” state. The body 22 of display stand 20 has a recess or opening 25 that is sized and shaped to receive a stem 35 of the sensor base 30. In that regard, sensor base 30 comprises a body 32 and a stem 35 depending from the body that is configured to be received within the opening 25 of the display stand 20. The stem 35 of the sensor base 30 may be permanently affixed to the body 22 within the opening 25 of the display stand 20. Preferably, however, stem 35 is received within the opening 25 of the display stand 20 in a secure interference fit so that a camera sensor according to the invention is interchangeable on a different display stand 20. Furthermore, the body 22 of display stand 20 and the stem 35 of the sensor base 30 may each be provided with complimentary external and/or internal geometry features for aligning sensor base 30 relative to display stand 20 in a predetermined desired orientation.

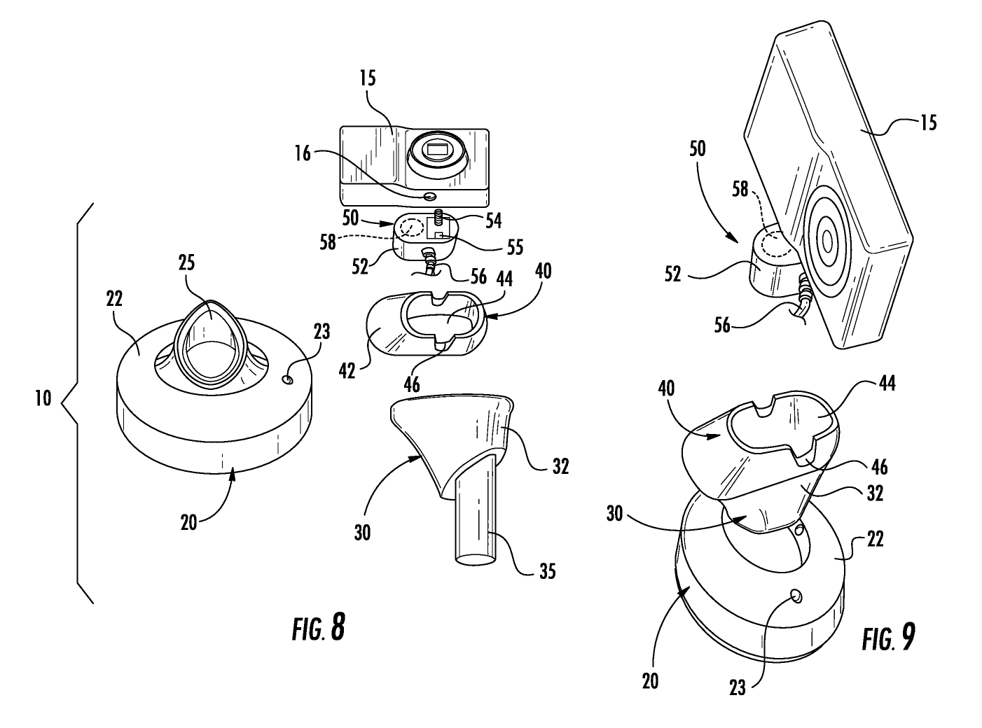

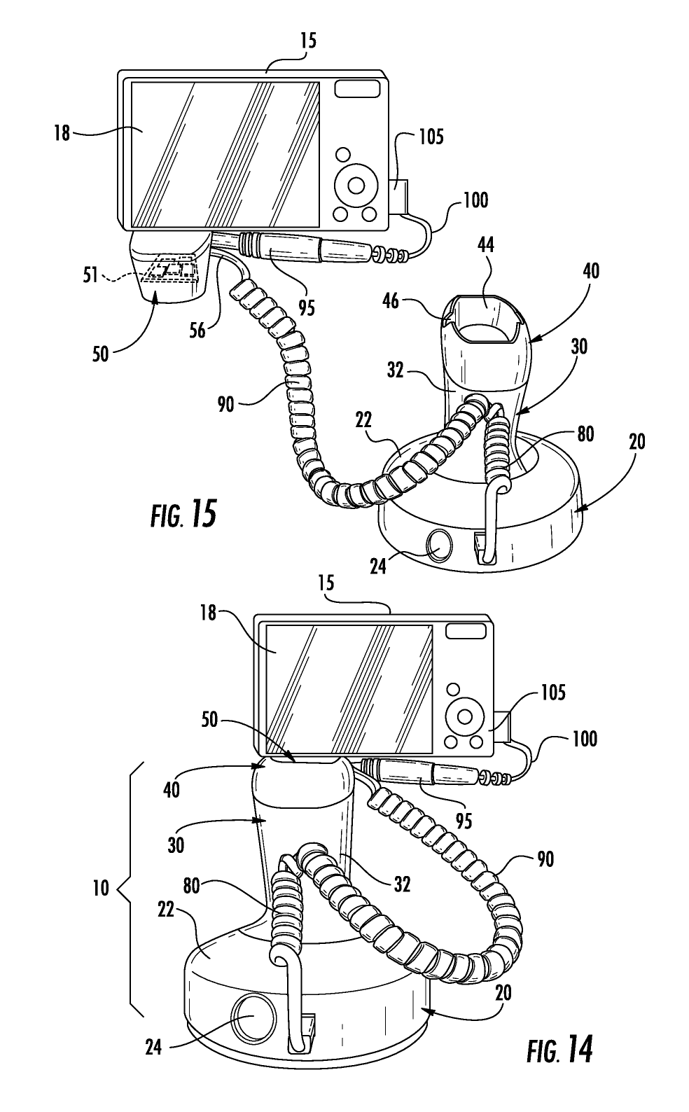

FIG. 9 shows the handheld camera 15 and the components of the merchandise display security device 10 in an assembled configuration. In particular, FIG. 9 shows the stem 35 of the sensor base 30 disposed within the opening 25 of the display stand 20 and the reversible sensor housing 40 seated on the sensor base. In addition, FIG. 9 shows the reversible adapter 50 attached to the handheld camera 15. The reversible adapter 50 comprises a body 52 that retains a captive, externally-threaded fastener 54 operable for engaging an internally-threaded tripod mount 16 (FIG. 8) provided on the underside of the handheld camera 15. As best shown in FIG. 1, adapter 50 further comprises a sensor switch 55 that is biased in an extended position. As such, the sensor switch 55 moves from the extended position to a retracted, or depressed, position as the fastener 54 secures the handheld camera 15 on the adapter 50. In the depressed position, the sensor switch 55 completes (i.e. closes) an electronic monitoring circuit of sensor electronics 51 (FIG. 15) disposed within the body 52 of the adapter 50 that is electrically connected to monitoring electronics 21 disposed within display stand 20, as will be described, to indicate that the handheld camera 15 is securely attached to the adapter. In the event that a potential thief attempts to separate the handheld camera 15 from the adapter 50, for example by unscrewing fastener 54, or alternatively, by rotating the camera relative to the adapter, biased sensor switch 55 extends and interrupts (i.e. opens) the monitoring circuit of sensor electronics 51 to indicate that the handheld camera is no longer securely attached to the adapter. In response to the sensor switch 55 changing from a “secured” state to an “unsecured” or “alarm” state, the monitoring electronics 21 of the display stand 20 activate the audible alarm and/or visible alarm (e.g. LED 23) to alert store personnel to a possible theft.

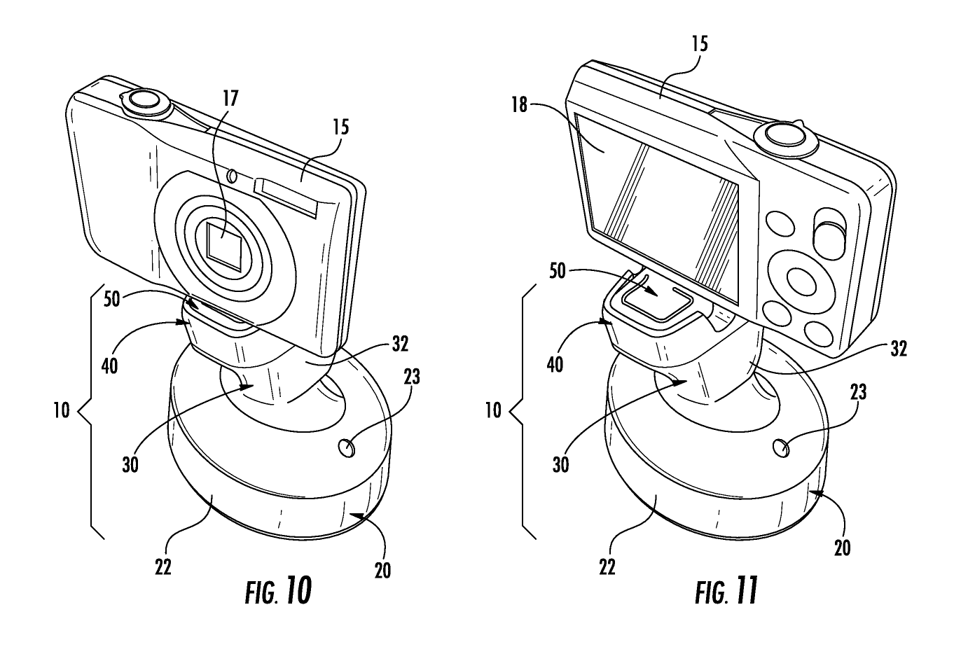

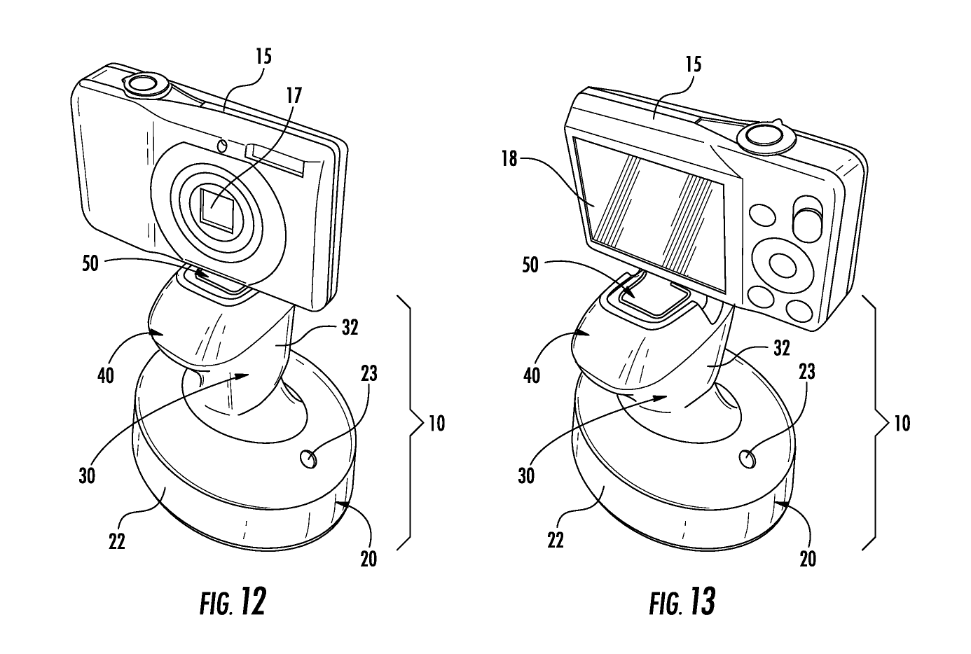

The reversible sensor housing 40 comprises a body 42 defining an opening 44 therethrough or receiving adapter 50. The underside of body 42 of sensor housing 40 has a geometry that is complimentary to the geometry on the topside of the body 32 of the sensor base 30 for a purpose to be explained hereafter with reference to FIG. 10 and FIG. 11. In particular, the geometry of the topside of the body 32 of the sensor base 30 and the underside of the body 42 of the sensor housing 40 are both complimentary and symmetric to one another. As a result, the reversible sensor housing 40 may be seated on the sensor base 30 in either one of two different, and opposite, orientations. Similarly, the underside of the body 52 of the adapter 50 has a geometry that is complimentary to the geometry of the topside of the body 42 of the sensor housing 40 for a purpose to be explained hereinafter with reference to FIG. 12 and FIG. 13. In particular, the opening 44 of the body 42 of the sensor housing 40 is sized and shaped to receive the body 52 of the adapter 50. The geometry of opening 44 formed in sensor housing 40 and body 52 of adapter 50 are both complimentary and symmetric to one another. Furthermore, the body 42 of sensor housing 40 has a pair of laterally opposed recesses 46 formed therein for receiving a strain relief component 56 of cable 90, as will be described hereinafter. As a result, the reversible adapter 50 may be positioned within the opening 44 of the sensor housing 40 in either of the two different, and opposite, orientations.

As previously described, the body 32 of sensor base 30 has three openings formed in the topside for each receiving a magnet 38, or alternatively, an insert made of a magnetically attractive material. In this embodiment, the body 52 of adapter 50 is provided with a complimentary magnet 58 adjacent fastener 54 for releasably retaining the reversible adapter 50 on the sensor base 30. As will be readily apparent to those skilled in the art, a magnet and an opposed complimentary magnetically attractive material disposed on the topside of the sensor base 30 and on the underside of the adapter 50, respectively, releasably retain the adapter on the sensor base in either of the two, different and opposite orientations.

FIG. 10 shows the handheld camera 15 and the merchandise display security device 10 in an assembled configuration for displaying and protecting the handheld camera against theft. The handheld camera 15 is attached to the adapter 50 by engaging the fastener 54 of the adapter with the tripod mount 16 of the handheld camera. The reversible sensor housing 40 is seated on the sensor base 30 and the display stand 20 in one of the two different and opposite orientations previously mentioned such that the handheld camera is positioned closer to the viewpoint of the potential purchaser. As previously described, the stem 35 of the sensor base 30 may be secured within the opening 25 formed in the body 22 of the display stand 20 by an interference fit If desired, the body 42 of the sensor housing 40 may be likewise secured onto the body 32 of the sensor base 30, for example by an interference fit or by resilient prongs on body 42 that engage slots formed in the body 32. The reversible adapter 50 is then positioned within opening 44 of sensor housing 40 on sensor base 30 and display stand 20 in a desired one of the two different, and opposite, orientations previously mentioned. In particular, the body 52 of adapter 50 is releasably retained on the sensor base 30 by the attraction between magnet 58 and one of the magnets 38 disposed in body 32 with the handheld camera 15 displayed in a “forward-facing” orientation so that the lens side 17 of the handheld camera is prominently displayed to a potential purchaser. A retailer may desire to display the handheld camera 15 in the forward-facing orientation for the purpose of drawing the potential purchaser's attention to the lens side 17, which may be aesthetically pleasing and include indicia indentifying the manufacturer of the camera.

FIG. 11 shows the handheld camera 15 and the merchandise display security device 10 in an assembled configuration for displaying and protecting the handheld camera against theft. The handheld camera 15 is attached to the adapter 50 by engaging the fastener 54 of the adapter with the tripod mount 16 of the handheld camera. The reversible sensor housing 40 is seated on the sensor base 30 and the display stand 20 in the manner and the orientation described above with reference to FIG. 10. In this embodiment, the reversible adapter 50 is then positioned within opening 44 of sensor housing 40 in the other of the two different, and opposite, orientations. In particular, the body 52 of adapter 50 is releasably retained on the sensor base 30 by the attraction between magnet 58 and a different one of the three magnets 38 disposed in body 32 with the handheld camera 15 displayed in a “rearward-facing” orientation so that the viewfinder/video screen 18 of the handheld camera is prominently displayed to a potential purchaser. A retailer may desire to display the handheld camera 15 in the rearward-facing orientation for the purpose of drawing the potential purchaser's attention to the quality and characteristics of the viewfinder/video screen 18, which may be a distinguishing feature of that model of handheld camera.

It should be noted that the adapter 50 may also be used with larger cameras and video recorders, such as DSR cameras and camcorders, in addition to smaller cameras, such as “point and shoot” handheld cameras. For use with the DSLR camera 12 of FIGS. 2-7, the adapter 50 is secured to the reversible sensor housing 40 within opening 44 so as to replace the reversible sensor housing 60 previously shown and described. The DSLR camera 12 is attached to the adapter 50 by engaging fastener 54 of the adapter with the tripod mount (not shown) of the DSLR camera. The reversible sensor housing 40 is then seated on the sensor base 30 and the display stand 20 as desired either in the forward-facing orientation previously shown and described with reference to FIG. 4, or alternatively, in the rearward-facing orientation previously shown and described with reference to FIG. 5. The expanded footprint of the body 42 of the sensor housing 40 in conjunction with the extended stem 35 of the sensor base 30 function to support the additional weight of the DSLR camera and to counteract any eccentric moment produced by the aggregate center-of-gravity of the combined DSLR camera 12 and removable lens 13 on display stand 20.

FIG. 12 shows the handheld camera 15 and the merchandise display security device 10 in an assembled configuration for displaying and protecting the handheld camera against theft. The handheld camera 15 is attached to the adapter 50 in the aforementioned manner utilizing fastener 54 and the reversible sensor housing 40 is seated on the sensor base 30 and the display stand 20 in an orientation that is opposite to the orientation shown in FIG. 10 and FIG. 11. As a result, the handheld camera 15 will be displayed in a “recessed” location relative to the location of the handheld camera shown in FIG. 10 and FIG. 11 that is farther from the viewpoint of the potential purchaser. The reversible adapter 50 is then positioned within the opening 44 of sensor housing 40 on sensor base 30 and display stand 20 so that the lens side 17 of the handheld camera is prominently displayed to a potential purchaser in a recessed, forward-facing orientation.

FIG. 13 shows the handheld camera 15 and the merchandise display security device 10 in an assembled configuration for displaying and protecting the handheld camera against theft. The handheld camera 15 is attached to the adapter 50 in the aforementioned manner utilizing fastener 54 and the reversible sensor housing 40 is again seated on the sensor base 30 and the display stand 20 in the recessed orientation shown in FIG. 12 (i.e. opposite to the orientation shown in FIG. 10 and FIG. 11). The reversible adapter 50 is then positioned within the opening 44 of sensor housing 40 on sensor base 30 and display stand 20 in an orientation that is opposite to that shown in FIG. 12 so that the viewfinder/video screen 18 of the handheld camera 15 is prominently displayed to a potential purchaser in a recessed, rearward-facing orientation.

It will be readily understood and appreciated by those skilled in the art that once the handheld camera 15 is attached to the adapter 50 and the sensor housing 40 is seated on the sensor base 30 and display stand 20, only the orientation of the adapter 50 relative to the sensor housing 40 need be reversed in order to alternate between the recessed, forward-facing orientation shown in FIG. 12 and the recessed, rearward-facing orientation shown in FIG. 13.

FIG. 14 is a rear view of the handheld camera 15 and the merchandise display security device 10 with the handheld camera being displayed and protected against theft in the recessed, forward-facing orientation of FIG. 12. As such, the reversible adapter 50 of the camera sensor is positioned within opening 44 of the reversible sensor housing 40, and the sensor housing is seated on the sensor base 30 and display stand 20 in the manner described with reference to FIG. 12. FIG. 15 is a rear view similar to FIG. 14 with the handheld camera 15 and the reversible adapter 50 of the camera sensor removed from the opening 44 of the sensor housing 40 so that the handheld camera may be evaluated by a potential purchaser.

As shown in FIG. 14 and FIG. 15, the first multi-conductor cable 80 extends between the body 22 of the display stand 20 and the body 32 of the sensor base 30 to electrically interconnect the monitoring electronics 21 (FIG. 6 and FIG. 7) disposed within the display stand and the regulator electronics 31 (FIG. 6 and FIG. 7) disposed within the sensor base. As shown herein, an optical port 24 may be provided in the body 22 of the display stand 20 and operably coupled to the monitoring electronics 21 for controlling the operation of (i.e. arming and disarming) the merchandise display security device 10. Display stand 20 may further contain an internal battery for providing power to the monitoring electronics 21 and the regulator electronics 31, or alternatively or additionally, may comprise a main power cord (not shown) that is electrically connected to an external power source, such as a direct current (DC) transformer and an alternating current (AC) electrical outlet.

As shown in FIG. 14 and FIG. 15, the second multi-conductor cable 90 extends between the sensor base 30 and the adapter 50 to electrically interconnect the regulator electronics 31 with sensor electronics 51 disposed within the adapter 50 and electrically connected to the biased sensor switch 55 that engages the underside of the handheld camera 15. If desired, current and/or voltage feedback electronics may also be provided on sensor electronics 51 disposed within adapter 50 for increasing or decreasing the amount of current and/or voltage needed for operating the handheld camera 15. As shown herein, cable 90 may comprise an optional strain relief component 56 adjacent the body 52 of adapter 50 for alleviating excessive bending stress exerted on the cable when the handheld camera 15 is manipulated by a potential purchaser. Furthermore, cable 90 has a suitable length, or alternatively, is an extensible and retractable cable, such as the helical coil cable shown herein, to allow a potential purchaser to closely examine and operate the handheld camera 15 at a comfortable distance away from the display stand 20 and sensor base 30. As previously described, regulator electronics 31 is operable for providing an appropriate operating current and/or voltage to the handheld camera 15. As previously described, monitoring electronics 21 is operable for monitoring the state of the monitoring circuit of the sensor electronics 51 associated with sensor switch 55 and for activating an audible and/or visible alarm (e.g. LED 23) to alert store personnel to a possible theft.

As shown in FIG. 14 and FIG. 15, the third multi-conductor cable 100 extends between the power connector 95 provided on cable 90 (or alternatively on adapter 50) and the power input port 105 provided on the handheld camera 15. As previously described, cable 100 carries conductors for delivering an appropriate operating current and/or voltage to the handheld camera 15. It will be readily appreciated and understood by those skilled in the art that any of the cables 80, 90, 100 may be provided with releasable connectors on one or both ends, or alternatively, may be hard-wired directly to the corresponding electronics 21, 31, 51 disposed within display stand 20, sensor base 30 and adapter 50, respectively. Preferably, at least the end of cable 80 that is connected to the display stand 20 is provided with a releasable connector so as to facilitate the interchangeability of a different display stand 20 with the same sensor base 30. Similarly, at least the end of cable 90 that is connected to the adapter 50 is provided with a releasable connector so as to facilitate the interchangeability of different adapters 50 with the same sensor base 30. Preferably, both ends of cable 100 are provided with a releasable connector, and the cable 90 or the adapter 50 is provided with a power connector 95 that has a standard configuration, so as to facilitate the use of the same adapter 50 with different cables 100 commonly referred to in the art as “power adapter cords” or “pigtails” having different connectors compatible with the configuration of the power input port 105 provided on the handheld camera 15.

It should be noted that the complimentary and symmetric geometry of the opening 44 on the reversible sensor housing 40 and the underside of the reversible adapter 50 permits the potential purchaser to replace the handheld camera 15 on the display stand 20 in either the forward-facing orientation or the rearward-facing orientation. Furthermore, the retailer may quickly and easily modify the display of the handheld camera 15 from the forward-facing orientation shown in FIG. 10 and FIG. 12 to the rearward-facing orientation shown in FIG. 11 and FIG. 13 by reversing the position of the adapter 50 relative to the sensor housing 40. In addition, the retailer may quickly and easily modify the display of the handheld camera 15 from the forward-facing orientation shown in FIG. 10 to the recessed, rearward-facing orientation shown in FIG. 13 by reversing the position of the sensor housing 40 relative to the sensor base 30 and the display stand 20. In the same manner, the retailer may quickly and easily modify the display of the handheld camera 15 from the rearward-facing orientation shown in FIG. 11 to the recessed, forward-facing orientation shown in FIG. 13.

The foregoing has shown and described one or more exemplary embodiments of a merchandise display security device including a camera sensor having a reversible sensor housing and a reversible adapter. One or more exemplary embodiments of merchandise display security devices and methods for displaying larger cameras and video recorders, such as DSLR cameras and camcorders, as well as for displaying smaller cameras, such as “point and shoot” or “handheld” cameras, have also been shown and described. It should be noted that the specific components of the reversible camera sensor and the particular steps identified for the methods for displaying cameras are exemplary only, and that other essentially equivalent components and steps may be substituted for those shown and described herein without departing from the intended content and scope of the invention. Specifically, many modifications and other embodiments of the invention will be readily apparent to one skilled in the art having the benefit of the teachings presented in the foregoing description and accompanying drawings. Therefore, it is to be understood that the invention is not limited to the exemplary embodiments shown and described herein and that variations of and modifications to the disclosed embodiments, as well as undisclosed embodiments within the ordinary skill of the art, are intended to be included within the content and scope of the appended claims.

That which is claimed is:

1. A camera sensor for a merchandise display security device comprising:
a sensor base comprising a body; and
a reversible sensor housing comprising a body configured for being positioned on the body of the sensor base in either one of two opposite orientations.

2. A camera sensor according to claim 1, wherein the body of the sensor base has a topside defining a symmetric geometry and the body of the sensor housing has an underside defining a symmetric geometry that is complimentary to the symmetric geometry of the body of the sensor base.

3. A camera sensor according to claim 1, wherein the body of the sensor base and the body of the sensor housing each have at least one magnet disposed thereon for releasably retaining the sensor housing on the sensor base.

4. A camera sensor according to claim 1, further comprising a display stand comprising a body defining an opening for receiving the sensor base therein.

5. A camera sensor according to claim 1, wherein the body of the sensor housing retains a fastener operable for engaging a tripod mount provided on a camera.

6. A camera sensor according to claim 1, wherein the sensor housing further comprises a sensor switch for indicating a secured state and an unsecured state of a camera attached to the sensor housing.

7. A camera sensor according to claim 6, further comprising sensor electronics having an electronic circuit electrically connected to the sensor switch and monitoring electronics electrically connected to the sensor electronics for monitoring the secured state and the unsecured state of the sensor switch and for activating an alarm in the event that the sensor switch indicates an unsecured state of a camera attached to the sensor housing.

8. A camera sensor according to claim 1, further comprising regulator electronics for supplying an operating current and/or voltage to a camera attached to the sensor housing.

9. A camera sensor according to claim 1, further comprising a reversible adapter comprising a body configured for being positioned on the body of the sensor housing in either one of two opposite orientations.

10. A camera sensor according to claim 9, wherein the body of the sensor housing has an opening therein defining a symmetric geometry and the body of the adapter defines a symmetric geometry that is complimentary to the symmetric geometry defined by the opening of the body of the sensor housing.

11. A camera sensor according to claim 9, wherein the body of the sensor base and the body of the adapter each have at least one magnet disposed thereon for releasably retaining the adapter on the sensor base.

12. A camera sensor according to claim 9, further comprising a display stand comprising a body defining an opening for receiving the sensor base therein.

13. A camera sensor according to claim 9, wherein the body of the adapter retains a fastener operable for engaging a tripod mount provided on a camera.

14. A camera sensor according to claim 9, wherein the adapter further comprises a sensor switch for indicating a secured state and an unsecured state of a camera attached to the adapter.

15. A camera sensor according to claim 14, further comprising sensor electronics having an electronic circuit electrically connected to the sensor switch and monitoring electronics electrically connected to the sensor electronics for monitoring the secured state and the unsecured state of the sensor switch and for activating an alarm in the event that the sensor switch indicates an unsecured state of a camera attached to the adapter.

16. A camera sensor according to claim 9, further comprising regulator electronics for supplying an operating current and/or voltage to a camera attached to the adapter.

17. A camera sensor for a merchandise display security device configured for displaying a camera and protecting the camera against theft, the camera sensor comprising:
a display stand comprising a body having an opening;
a sensor base comprising a body configured for being received within the opening of the body of the display stand, the body of the sensor base having a topside defining a symmetric geometry; and
a reversible sensor housing comprising a body configured for being positioned on the sensor base in either one of two opposite orientations, the body of the sensor housing defining a symmetric geometry that is complimentary to the symmetric geometry of the sensor base.

18. A camera sensor according to claim 17, wherein the camera is attached to the sensor housing and the sensor housing is releasably attached to the sensor base such that the camera and the sensor housing are removable from the sensor base and the display stand.

19. A camera sensor for a merchandise display security device configured for displaying a camera and protecting the camera against theft, the camera sensor comprising:
a display stand comprising a body having an opening;
a sensor base comprising a body configured for being received within the opening of the body of the display stand;
a sensor housing comprising a body configured for being secured on the sensor base, the body of the sensor housing having an opening defining a symmetric geometry; and
a reversible adapter comprising a body configured for being positioned on the sensor housing in either one of two opposite orientations, the body of the adapter defining a symmetric geometry that is complimentary to the symmetric geometry defined by the opening of the body of the sensor housing.

20. A camera sensor according to claim 19, wherein the camera is attached to the adapter and the adapter is releasably attached to the sensor base such that the camera and the adapter are removable from the sensor housing, the sensor base and the display stand.
